(19) United States
(12) Patent Application Publication
(10) Pub. No.: US 2010/0111397 A1
(43) Pub. Date: May 6, 2010

(54) METHOD AND SYSTEM FOR ANALYZING BREAST CARCINOMA USING MICROSCOPIC IMAGE ANALYSIS OF FINE NEEDLE ASPIRATES

(75) Inventors: Hrushikesh GARUD, Parbhani (IN); Biswadip Mitra, Bangalore (IN); Debdoot Sheet, Kharagpur (IN); Priti Prasanna Maity, Kharagpur (IN); Ajoy Kumar Ray, Kharagpur (IN); Jyotirmoy Chatterjee, Kharagpur (IN); Chandan Chakraborty, Kharagpur (IN); Arindam Ghosh, Kharagpur (IN); Provas Banerjee, Birbhum (IN)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/605,394

(22) Filed: Oct. 26, 2009

(30) Foreign Application Priority Data
Oct. 31, 2008 (IN) 2659/CHE/2008

(51) Int. Cl. G06K 9/00

(52) U.S. Cl. 382/133

(57) ABSTRACT

Method and system for analyzing breast carcinoma using microscopic image analysis of fine needle aspirates. The method includes extracting a G-plane image from an image. The method also includes de-noising the G-plane image. Further, the method includes balancing histogram imbalance associated with the G-plane image. Furthermore, the method includes generating a binary image from the G-plane image. The method also includes filtering the binary image to yield a nuclear map. Further, the method includes extracting a nuclear contour from the nuclear map. Moreover, the method includes determining one or more parameters from at least one of the G-plane image, the nuclear map and the nuclear contour to enable detection of the breast lesion as one of malignant and non-malignant.

### REFERENCE TO PRIORITY APPLICATION

This application claims priority from Indian Provisional Application Serial No. 2659/CHE/2008 filed on Oct. 31, 2008, entitled “Cellular geometry features of epithelial cells in FNAC samples of benign and malignant breast lesions”, which is incorporated herein by reference in its entirety.

### TECHNICAL FIELD

Embodiments of the disclosure relate to analyzing of an image of a breast lesion.

### BACKGROUND

Breast carcinoma, occurs in both men and women, and is a common type of malignancy that can cause cancer death. It is desired to detect breast malignancy at an early stage in order to avoid deaths. Currently existing technique for classification of breast lesion as being malignant or not includes obtaining sample of the breast lesion through fine needle aspiration and examining the cells using microscope, after the cells are stained. However, examination is performed by experts and doctors, whose availability is limited.

In another existing technique, which is a result of a research performed by University of Wisconsin Madison, an image of the cells is generated and analyzed to determine malignancy. Analysis of a breast tissue aspirate sample is performed based on various parameters, for example geometrical attributes of the cell nuclei. Though, number of parameters considered for analysis is ten or more but still do not ensure best possible analysis. This is due to the inefficiency of parameter extraction techniques used and inability of parameter quantification techniques in expressing or representing the difference between benign and malignant classes. Moreover, with increase in number of parameters processing time and cost increases.

### SUMMARY

An example of a method for analyzing an image of a sample of a breast lesion includes extracting a G-plane image from the image. The method also includes de-noising the G-plane image. Further, the method includes balancing histogram imbalance associated with the G-plane image. Furthermore, the method includes generating a binary image from the G-plane image. The method also includes filtering the binary image to yield a nuclear map. Further, the method includes extracting a nuclear contour from the nuclear map. Moreover, the method includes determining one or more parameters from at least one of the G-plane image, the nuclear map, and the nuclear contour to enable detection of the breast lesion as one of malignant and non-malignant.

Another example of a method for analyzing an image of a sample of a breast lesion by an image processing unit includes extracting a G-plane image from the image. The method also includes processing the G-plane image to generate a nuclear contour and a nuclear map. Further, the method includes determining at least one of a radius of a cell nucleus of the breast lesion from the nuclear contour, a perimeter of the cell nucleus from the nuclear map, an area of the cell nucleus from the nuclear map, compactness of the cell nucleus from the perimeter and the area, smoothness of the cell nucleus from the radius and the nuclear contour, and texture of the cell nucleus from the nuclear map and the G-plane image. Furthermore, the method includes classifying the breast lesion as one of malignant and non-malignant based on at least one of the radius, the perimeter, the area, the compactness, the smoothness, and the texture.

An example of an image processing unit (IPU) for analyzing an image of a sample of a breast lesion includes an image and video acquisition module that electronically receives the image. The IPU includes an a digital signal processor (DSP) that is responsive to the receiving of the image to extract a G-plane image from the image and to process the G-plane image to generate a nuclear map and a nuclear contour. The DSP also processes at least one of the nuclear map, the G-plane image and the nuclear contour to determine a plurality of parameters that enable detection of the breast lesion as one of malignant and non-malignant.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the disclosure.

FIG. 1 is an environment for analyzing an image of a breast lesion, in accordance with one embodiment;

FIG. 2 is a block diagram of a system for analyzing an image of a breast lesion, in accordance with one embodiment;

FIG. 3 is a flow diagram illustrating a method for analyzing an image of a breast lesion, in accordance with one embodiment;

FIG. 4 is a flow diagram illustrating a method for analyzing an image of a breast lesion, in accordance with another embodiment; and

FIGS. 5A, 5B, 5C, 5D, 5E, 5F and 5G illustrate intermediate images generated during analysis of an image of a breast lesion, in accordance with one embodiment.

### DETAILED DESCRIPTION OF THE EMBODIMENTS

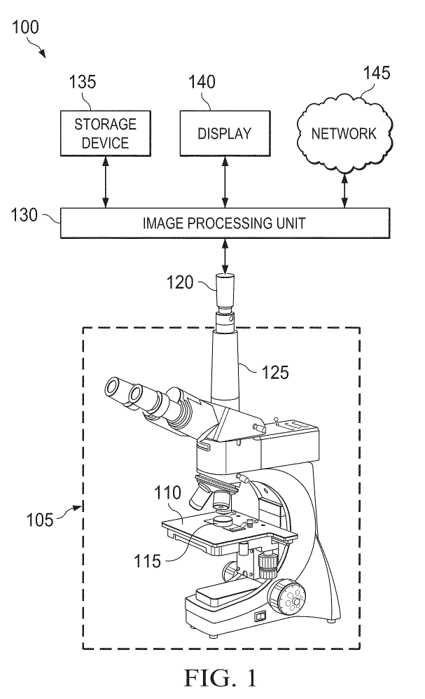

FIG. 1 is an environment 100 for analyzing an image of a sample, for example a sample of a breast lesion. The environment 100 includes a microscope 105. The microscope 105, for example a trinocular microscope or a robotic microscope includes a stage 110. A slide 115 is placed over the stage 110. The slide 115 includes the breast lesion.

In some embodiments, the sample of the breast lesion can be obtained using one or more techniques, for example fine needle aspiration cytology (FNAC), fine needle aspiration biopsy, core needle biopsy or excisional biopsy. The FNAC can be defined as a process of inserting a needle into a breast region to extract the breast lesion including cells, for example epithelial cells. The breast lesion is then spread on the slide 115, for example a glass slide. The breast lesion can then be stained by treating the breast lesion with Leishman stain for few minutes, for example 3 minutes and with Giemsa stain for another few minutes, for example 17 minutes. The staining can be referred to as Leishman Giemsa staining and the breast lesion obtained after staining can be referred to as Leishman Giemsa stained fine needle aspirated breast lesion. The slide 115 can then be washed with water and dried in air.

The microscope 105 can be coupled to an image sensor, for example a digital camera 120. The coupling can be performed using an opto-coupler 125, for example a phototube. The digital camera 120 acquires an image of the breast lesion. The image of the breast lesion can be acquired under 10×, 20×, 40×, 100× of primary magnification provided by the microscope 105. In one example, the digital camera 120 is capable of outputting the image having at least 1024×768 pixel resolution. In other embodiment, the digital camera 120 is capable of outputting the image having 1400×1328 pixel resolution.

The digital camera 120 can be coupled to an image processing unit (IPU) 130. The IPU can be a digital signal processor (DSP) based system. The digital camera 120 can be coupled to the IPU 130 through a network 145. In one example, the digital camera 120 is coupled to the IPU 130 via a direct link. Examples of direct link between camera and IPU 130 include, but are not limited to, BT656 and Y/C, universal serial bus port, and IEEE ports. The digital camera 120 can also be coupled to a computer which in turn is coupled to the network 145. Examples of the network 145 include, but are not limited to, internet, wired networks and wireless networks. The IPU 130 receives the image acquired by the digital camera 120 and processes the image.

In some embodiments, the IPU 130 can be embedded in the microscope 105 or in the digital camera 120. The IPU 130 processes the image to detect whether the breast lesion is malignant or non-malignant. The IPU 130 can be coupled to one or more devices for outputting result of processing. Examples of the devices include, but are not limited to, a storage device 135 and a display 140.

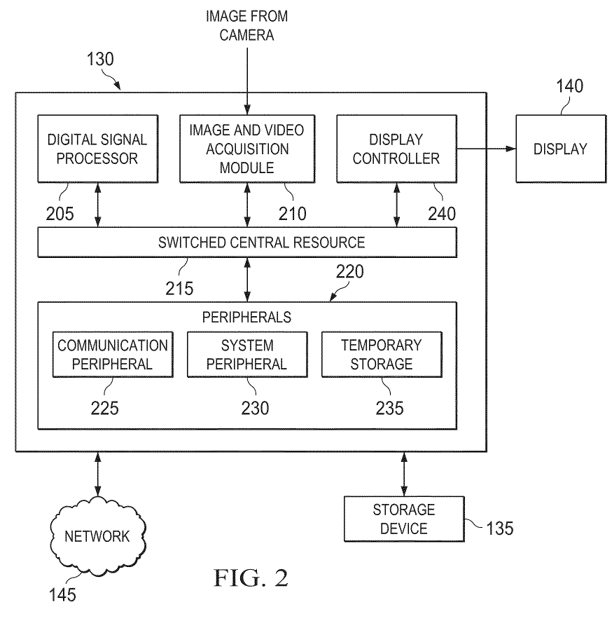

The IPU 130 can also be coupled to an input device, for example a keyboard, through which a user can provide an input. The IPU 130 includes one or more elements to analyze the image and is explained in conjunction with FIG. 2.

Referring to FIG. 2 now, the IPU 130 includes one or more peripherals 220, for example a communication peripheral 225, in electronic communication with other devices, for example a digital camera, the storage device 135, and the display 140. The IPU 130 can also be in electronic communication with the network 145 to send and receive data including images. The peripherals 220 can also be coupled to the IPU 130 through a switched central resource 215. The switched central resource 215 can be a group of wires or a hardwire used for switching data between the peripherals 220 or between components in the IPU 130. Examples of the communication peripheral 225 include ports and sockets. The IPU 130 can also be coupled to other devices for example at least one of the storage device 135 and the display 140 through the switched central resource 215. The peripherals 220 can also include a system peripheral 230 and a temporary storage 235. An example of the system peripheral 230 is a timer. An example of the temporary storage 235 is a random access memory.

An image and video acquisition module 210 electronically receives the image from an image sensor, for example the digital camera. In one example, the image and video acquisition module 210 can be a video processing subsystem (VPSS). The VPSS includes a front end module and a back end module. The front end module can include a video interface for receiving the image. The back end module can include a video encoder for encoding the image. The IPU 130 includes a digital signal processor (DSP) 205, coupled to the switched central resource 215, that extracts a G-plane (Green-plane) image from the image. In one example, the image can be in 24 bit RGB (Red, Green, and Blue) format. The G-plane image can be referred to as a part of the image corresponding to a G-plane of the 24 bit RGB format. The G-plane image can be used as Leishman Giemsa staining provides a desired contrast ratio in the G-plane.

The DSP 205 processes the G-plane image to generate a nuclear map and a nuclear contour. The nuclear map includes a cell nucleus of the breast lesion. The nuclear contour includes boundary of the cell nucleus of the breast lesion.

The DSP 205 processes at least one of the nuclear map, the G-plane image and the nuclear contour to determine a plurality of parameters that enable detection of the breast lesion as one of malignant and non-malignant.

In some embodiments, the DSP 205 also includes a classifier that compares the parameters with a predefined set of values corresponding to a type of cancer. If the parameters match the predefined set of values then the classifier determines the breast lesion to be malignant else as non-malignant. The classifier also generates abnormality marked image, based on comparison, which can then be displayed, transmitted or stored, and observed. The abnormalities marked image based on the plurality of parameters is displayed on the display 140 using a display controller 240.

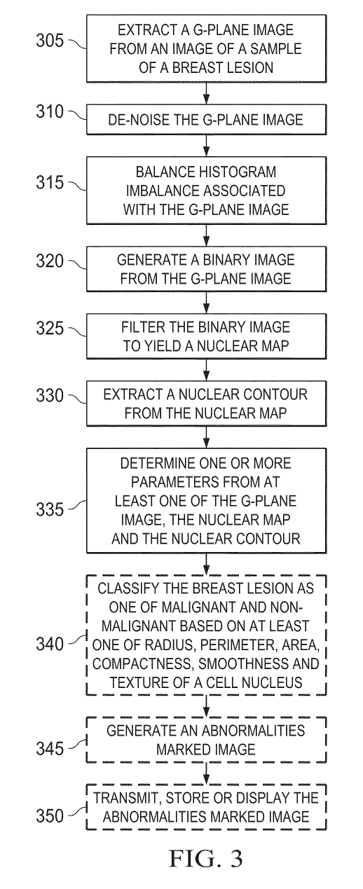

Referring to FIG. 3 now, a method for analyzing an image of a sample, for example a sample of a breast lesion is illustrated. The sample of the breast lesion can be obtained by fine needle aspiration. The breast lesion can be stained based on Leishman Giemsa staining. After staining the breast lesion can be referred to as a Leishman Giemsa stained fine needle aspirated sample of the breast lesion. The analyzing can be performed using an image processing unit (IPU). The IPU can be coupled to a source of the image. The source can be a digital camera or a storage device. The source, in turn, can be coupled to a microscope. The image is a 3-plane RGB (Red, Green, and Blue) image and can be captured when the breast lesion is placed on a stage of the microscope by the digital camera.

At step 305, a G-plane (Green-plane) image is extracted from the 3-plane RGB image. The Leishman Giemsa staining provides a desired contrast ratio of a cell nucleus of the breast lesion in the G-plane. The G-plane image includes the cell nucleus region and the surrounding region.

Based on various other types of staining, various other color planes of the image may also be extracted or other colour spaces can be used for representation storage and processing of the images.

At step 310, the G-plane image is de-noised. The G-plane image can be processed using a median filter to remove speckle noise and salt-pepper noise. The median filter can be referred to as non-linear digital filtering technique and can be used to prevent edge blurring. A median of neighborhood pixels' values can be calculated. The median can be calculated by repeating following steps for each pixel in the image.
a) Storing the neighborhood pixels in an array. The neighborhood pixels can be selected based on shape, for example a box or a cross. The array can be referred to as a window, and is odd sized.
b) Sorting the window in numerical order.
c) Selecting the median from the window as the pixels value.

Various other techniques can also be used for removing noises. Examples of the techniques include, but are not limited to, a technique described in “Digital Image Processing” by R. C. Gonzalez and R. E. Woods, 2e, pp. 253-255, which is incorporated herein by reference in its entirety.

At step 315, a histogram imbalance associated with the G-plane image is balanced. Balancing further helps in achieving the desired contrast between the cell nucleus and region surrounding the cell nucleus. A histogram associated with the G-plane image is used to adjust contrast. The histogram equalization technique as described in a book titled “Digital Image Processing” by R. C. Gonzalez and R. E. Woods, 2e, pp. 113-116, is incorporated herein by reference in its entirety for histogram balancing.

In some embodiments, the balancing also includes brightness compensation of the G-plane image. The image obtained after the histogram equalization has a mean brightness that is different than the G-plane image. To remove this difference the brightness compensation process is applied on the image. The brightness compensation is performed as follows—
Consider the G-plane image to be f and let f′ be the histogram equalized output, further if m and m′ are their mean brightness respectively, then for any pixel at a location (x, y) in the image, the output grayscale value in the output image f″ obtained after the brightness compensation step is given in equation (1).

$${f}^{″} ( x , y ) = \frac{m}{{m}^{′}} {f}^{′} ( x , y ) \qquad equation ( 1 )$$

At step 320, a binary image is generated from the G-plane image. The binary image can be defined as an image having two values for each pixel. For example, two colors used for the binary image can be black and white. Various techniques can be used for generating the binary image, for example Otsu auto-thresholding. The technique is described in a publication titled “A threshold selection method from gray-level histograms” by N Otsu published in IEEE Trans. Systems Man Cyber, vol. 9, pp. 62-66, 1979, which is incorporated herein by reference in its entirety.

At step 320, alternatively an entropy based approach for image thresholding can be used as described in publications titled “A new method for gray-level picture thresholding using the entropy of the histogram” by J. N. Kapur, P. K. Sahoo, and A. K. C. Wong, published in J. Comput. Vision Graphics Image Process., vol. 29, pp. 273-285, 1985 and “Picture thresholding using an iterative selection method”, by T. Ridler and S. Calvard, published in IEEE Trans. Systems Man, Cyber., vol. 8, pp. 630-632, 1978, which are incorporated herein by reference in its entirety.

At step 325, the binary image is filtered to yield a nuclear map. The nuclear map can be defined as an image in which the cell nucleus can be distinguished from surroundings. For example, the cell nucleus can be black and the surroundings can be white. The filtering can be performed based on a flood filling technique to remove artifacts due to the staining. The flood filling technique includes an algorithm that determines an area connected to a given node in a multi-dimensional array. The flood filling algorithm includes three parameters: a start node, a target color, and a replacement color. The algorithm searches for all nodes in the array which are connected to the start node by a path of the target color, and changes the target color to the replacement color. The algorithm uses a queue or stack data structure. For example, in the binary image the flood filling algorithm fills holes (white color inside the cell nucleus) with black color to yield the nuclear map.

At step 330, a nuclear contour is extracted from the nuclear map. The nuclear contour can be defined as an image including boundary region of the cell nucleus of the nuclear map. In some embodiments, the nuclear contour can also be generated using morphological boundary extraction technique as described in a book titled “Digital Image Processing” by R. C. Gonzalez and R. E. Woods, second edition, pp. 556-557, which is incorporated herein by reference in its entirety.

At step 335, one or more parameters are determined from at least one of the G-plane image, the nuclear map and the nuclear contour. The parameters include radius, area, perimeter, smoothness, compactness and texture of the cell nucleus.

The radius of the cell nucleus can be determined from the nuclear contour. The radius can be computed by averaging length of radial line segments. A radial line segment corresponds to a boundary point and can be defined as a line from centroid of the cell nucleus to that boundary point. The centroid of the cell nucleus is calculated from the nuclear map generated in step 325.

The perimeter of the cell nucleus can be determined from the nuclear contour. The perimeter can be computed as sum of distances between consecutive points on boundary of the cell nucleus.

The area of the cell nucleus can be determined from the nuclear map. The area can be measured by counting number of pixels on interior of the boundary of the cell nucleus and adding one half of the pixels on the perimeter. The one half of the pixels on the perimeter are considered to correct for error that can be caused by digitization during generation of the binary image as described in “Cancer diagnosis via linear programming” Mangasarian and W. H. Wolberg, SIAM News, vol. 23, no. 5, September 1990, pp 1-18, which is incorporated herein by reference in its entirety.

The compactness of the cell nucleus can be determined from the nuclear map and the nuclear contour. The compactness can be computed as ratio of square of the perimeter and the area.

The smoothness of the cell nucleus can be determined from the nuclear contour. As illustrated in equation (2), the smoothness can be determined by measuring difference between length of each radial line and mean length of two radial lines surrounding the each radial line, and dividing summation of the differences corresponding to the radial lines with the perimeter.

$$Smoothness = \frac{{\sum }_{points} \vert r ( i ) - \frac{r ( i - 1 ) + r ( i + 1 )}{2}}{perimeter} \qquad equation ( 2 )$$

The texture of the cell nucleus can be determined from the G-plane image and the nuclear map. The texture is determined by measuring the variation of grayscale intensities of the pixels in G-plane image, which are marked as the nuclear region in the nuclear map. To measure variation of grayscale images the technique described in “Multiresolution gray scale and rotation invariant texture analysis with local binary pattern” T. Ojala, M. Pietikäinen, and T. M\ddot{}aenpää. PAMI, 24:971-987, 2002″, is incorporated herein by reference in its entirety.

The parameters enable detection of the breast lesion as one of malignant and non-malignant. Malignant can be defined as cancerous. Non-malignant can be defined as being non-cancerous, for example being benign. The accuracy of detection improves due to the parameters. In some embodiments, a subset of the parameters can be used for detection based on accuracy desired. Reduction in number of the parameters being processed helps in reducing computational requirement of the DSP.

In some embodiments, the method can stop at step 335. The parameters can be stored for further processing.

In some embodiments, at step 340, the breast lesion can be classified as one of malignant and non-malignant based on at least one of the radius, the perimeter, the area, the compactness, the smoothness and the texture of the cell nucleus. The classification can be done by comparing the parameters with a predefined set of values for different type of cancers. For example, cancers can be differentiated based on degrees. The predefined set of values can be different for different type of cancers. A cancer can be detected when the parameters satisfy the predefined set of values. Each predefined value can be a number or a range.

Various techniques can be used for classification, for example a technique described in “Bayesian Classifier”, by Duda R. O., Hart P. E., and Stork D. G, published in “Pattern Classification”, Wiley, 2005 can be used and is incorporated herein by reference in its entirety.

In some embodiments, at step 345, an abnormalities marked image can be generated based on the parameters. The abnormalities can be marked based on the comparing performed at step 340.

In some embodiments, at step 350, at least one of transmitting the abnormalities marked image, storing the abnormalities marked image, and displaying the abnormalities marked image can be performed. The abnormalities marked image can then be used by doctors and experts for disease diagnosis.

It is noted that several cell nuclei can be analyzed using the method described in FIG. 3. A cluster of cell nuclei can also be considered.

It is noted that the method can be used for analysis of the fine needle aspirates of the tissue lesions other than the breast lesions. A G-plane image can be extracted and processed to determine parameters which might differ from that needed for the breast lesion.

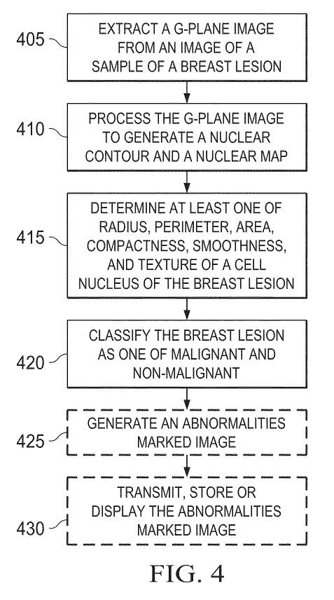

Referring to FIG. 4 now, another method for analyzing an image of a sample of the breast lesion. The breast lesion can be obtained using Fine needle aspiration technique. The breast lesion can be stained with Leishman Giemsa (LG) staining. After staining the breast lesion can be referred to as a Leishman Giemsa stained fine needle aspirated breast lesion. The analyzing can be performed using a processor, for example a DSP. The DSP can be coupled to a source of the image. The source can be a digital camera or a storage device. The source, in turn, can be coupled to a microscope. The image can be captured when the breast lesion is placed on a stage of the microscope by the digital camera.

At step 405, a G-plane image is extracted from the image. The LG staining provides a desired contrast level for a cell nucleus and its background.

At step 410, the G-plane image is processed to generate a nuclear contour and a nuclear map. Various techniques can be used for generating the nuclear contour and the nuclear map, for example techniques described in FIG. 3.

In some embodiments, processing includes de-noising the G-plane image, balancing histogram imbalance associated with the G-plane image, generating a binary image from the G-plane image, filtering the binary image to yield the nuclear map, and extracting the nuclear contour from the nuclear map.

At step 415, at least one of a radius, a perimeter, an area, compactness, smoothness and texture of a cell nucleus of the breast lesion is determined. The radius, the perimeter and the smoothness of the cell nucleus can be determined from the nuclear contour. The area of the cell nucleus can be determined from the nuclear map. The compactness of the cell nucleus can be determined from the nuclear map and the nuclear contour. The texture of the cell nucleus can be determined from the G-plane image and the nuclear map. Various techniques can be used for determining the parameters, for example techniques described in FIG. 3.

In some embodiments, at step 420, the breast lesion can be classified as one of malignant and non-malignant based on at least one of the radius, the perimeter, the area, the compactness, the smoothness and the texture of the cell nucleus. Various techniques can be used for classification, for example techniques described in FIG. 3.

In some embodiments, at step 425, an abnormalities marked image can be generated based on the parameters. Various techniques can be used for generation, for example techniques described in FIG. 3.

In some embodiments, at step 430, at least one of transmitting the abnormalities marked image, storing the abnormalities marked image, and displaying the abnormalities marked image can be performed. The abnormalities marked image can then be used by doctors and experts.

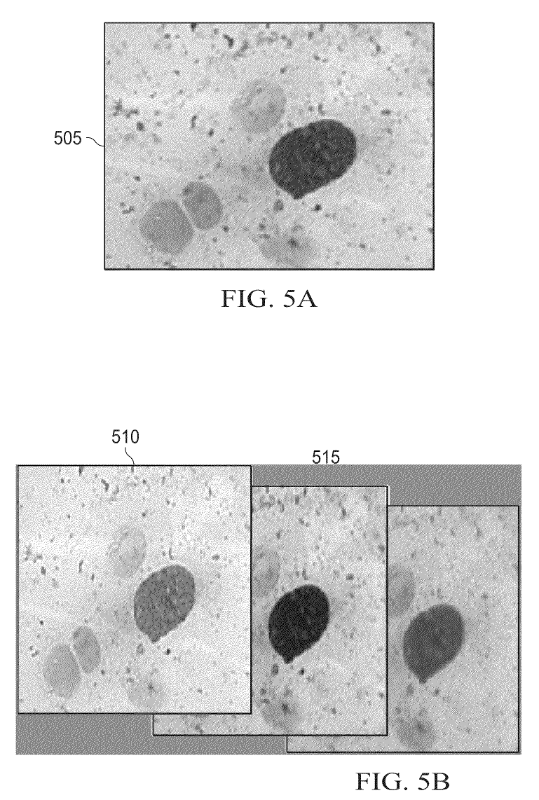

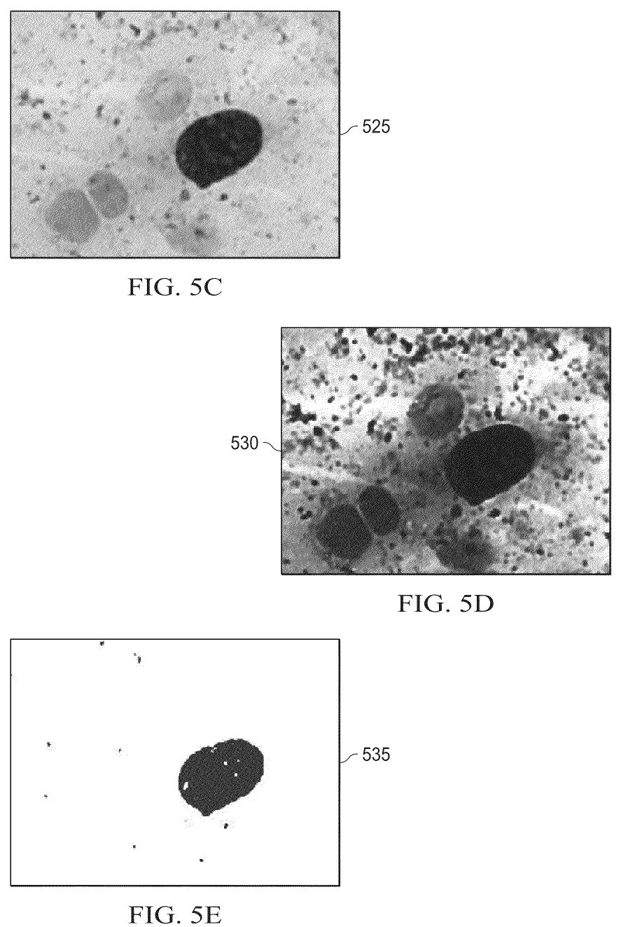

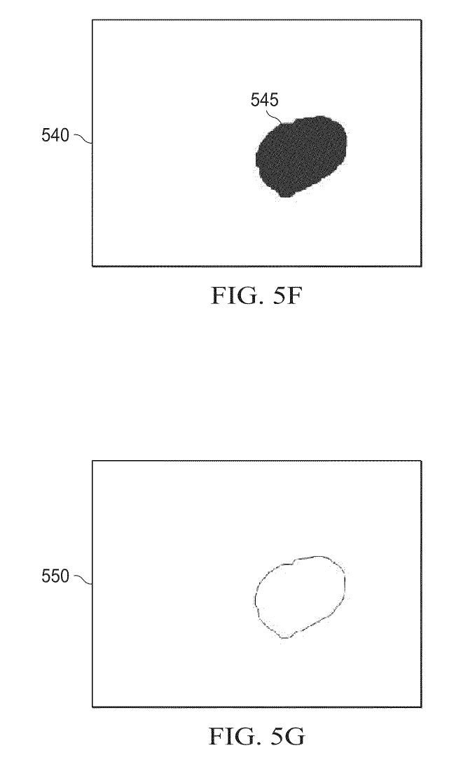

FIGS. 5A, 5B, 5C, 5D, 5E, 5F and 5G illustrate intermediate images generated during analysis of an image of a breast lesion.

FIG. 5A illustrates an image 505 of a breast lesion. The image 505 is received by a DSP. The image 505 is represented as grayscale image and can be a colored image. The image 505 includes several cells, for example epithelial cells of the breast lesion.

FIG. 5B illustrates an R-plane image 510, a G-plane image 515 and a B-plane image 520 of the image 505. The G-plane image 515 has better contrast ratio as compared to the R-plane image 510 and the B-plane image 520.

FIG. 5C illustrates an image 525 obtained from de-noising of the G-plan image 515 using median filter.

FIG. 5D illustrates an image 530 obtained from histogram equalization and brightness compensation of the image 525.

FIG. 5E illustrates a binary image 535 obtained from auto-thresholding of the image 530.

FIG. 5F illustrates a nuclear map 540 obtained from flood filling of the binary image 535. The nuclear map 540 includes a cell nucleus 545.

FIG. 5G illustrates a nuclear contour 550 extracted from the image 540. The nuclear contour 550 includes boundary of the cell nucleus 545.

A plurality of parameters, for example a radius, a perimeter, an area, compactness, smoothness and texture of the cell nucleus 545, are determined. Values of the parameters can then be used for classification. An example of the values corresponding to the image 505 is illustrated in Table 1.

TABLE 1

| | NON-MALIGNANT, FOR | | | |
|---|---|---|---|---|
| | EXAMPLE BENIGN CELL | | MALIGNANT CELL | |
| PARAMETER | NUCLEUS VALUES | | NUCLEUS VALUES | |
| Radius | 5.94 | μm | 8.04 | μm |
| Perimeter | 34.62 | μm | 65.16 | μm |
| Area | 34.62 | μm² | 203.47 | μm² |

| | | |
|---|---|---|
| Compactness | 10.8740 | 20.8661 |
| Smoothness | 11.2324 | 8.5073 |
| Texture | 1.9735 | 1.7591 |

In the foregoing discussion, the term “coupled or connected” refers to either a direct electrical connection or mechanical connection between the devices connected or an indirect connection through intermediary devices.

The foregoing description sets forth numerous specific details to convey a thorough understanding of embodiments of the disclosure. However, it will be apparent to one skilled in the art that embodiments of the disclosure may be practiced without these specific details. Some well-known features are not described in detail in order to avoid obscuring the disclosure. Other variations and embodiments are possible in light of above teachings, and it is thus intended that the scope of disclosure not be limited by this Detailed Description, but only by the Claims.

What is claimed is:

1. A method for analyzing an image of a sample of a breast lesion, the method comprising:
extracting a G-plane image from the image;
de-noising the G-plane image;
balancing histogram imbalance associated with the G-plane image;
generating a binary image from the G-plane image;
filtering the binary image to yield a nuclear map;
extracting a nuclear contour from the nuclear map; and
determining one or more parameters from at least one of the G-plane image, the nuclear map and the nuclear contour to enable detection of the breast lesion as one of malignant and non-malignant.

2. The method as claimed in claim 1, wherein analyzing the image comprises
analyzing the image by an image processing unit (IPU), the IPU being electronically coupled to a source of the image.

3. The method as claimed in claim 1, wherein analyzing the image comprises
analyzing the image of a Leishman Giemsa stained fine needle aspirated breast lesion.

4. The method as claimed in claim 1, wherein de-noising the G-plane image comprises
de-noising speckle noise and salt-pepper noise associated with the G-plane image based on median filter.

5. The method as claimed in claim 1, wherein balancing the histogram imbalance comprises
compensating brightness of the G-plane image.

6. The method as claimed in claim 1, wherein generating the binary image comprises
generating the binary image based on Otsu auto-thresholding technique.

7. The method as claimed in claim 1, wherein filtering the binary image comprises
filtering the binary image based on flood filling technique.

8. The method as claimed in claim 1, wherein extracting the nuclear contour comprises
extracting the nuclear contour based on morphological boundary extraction technique.

9. The method as claimed in claim 1, wherein determining the one or more parameters comprises
determining at least one of:
a radius of a cell nucleus of the breast lesion from the nuclear contour;
a perimeter of the cell nucleus from the nuclear contour;
an area of the cell nucleus from the nuclear map;
compactness of the cell nucleus from the perimeter and the area;
smoothness of the cell nucleus from the radius and the nuclear contour; and
texture of the cell nucleus from the nuclear map and the G-plane image.

10. The method as claimed in claim 1 and further comprising:
classifying the breast lesion as one of malignant and non-malignant;
generating an abnormalities marked image based on the plurality of parameters; and
performing at least one of
transmitting the abnormalities marked image;
storing the abnormalities marked image; and
displaying the abnormalities marked image.

11. A method for analyzing an image of a sample of a breast lesion by an image processing unit, the method comprising:
extracting a G-plane image from the image;
processing the G-plane image to generate a nuclear contour and a nuclear map;
determining at least one of
a radius of a cell nucleus of the breast lesion from the nuclear contour,
a perimeter of the cell nucleus from the nuclear contour,
an area of the cell nucleus from the nuclear map,
compactness of the cell nucleus from the perimeter and the area,
smoothness of the cell nucleus from the radius and the nuclear contour, and
texture of the cell nucleus from the nuclear map and the G-plane image; and
classifying the breast lesion as one of malignant and non-malignant based on at least one of the radius, the perimeter, the area, the compactness, the smoothness, and the texture.

12. The method as claimed in claim 11, wherein processing the G-plane image comprises:
de-noising the G-plane image;
balancing histogram imbalance associated with the G-plane image;
generating a binary image from the G-plane image;
filtering the binary image to yield the nuclear map; and
extracting the nuclear contour from the nuclear map.

13. An image processing unit for analyzing an image of a sample of a breast lesion, the image processing unit comprising:
an image and video acquisition module that electronically receives the image; and
a digital signal processor (DSP) responsive to the receiving of the image to
extract a G-plane image from the image,
process the G-plane image to generate a nuclear map and a nuclear contour, and
process at least one of the nuclear map, the G-plane image, and the nuclear contour to determine a plurality of parameters that enable detection of the breast lesion as one of malignant and non-malignant.

14. The image processing unit as claimed in claim 13, wherein the image processing unit is coupled to an image sensor.

15. The image processing unit as claimed in claim 14, wherein the image sensor is optically coupled to a microscope.

16. The image processing unit as claimed in claim 14, wherein the image sensor comprises
a digital camera.

17. The image processing unit as claimed in claim 13, wherein the image processing unit is coupled to at least one of:
a display; and
a storage device.

18. The image processing unit as claimed in claim 13, wherein the image processing unit is coupled to
a network to enable reception and transmission.
